(19) United States
(12) Patent Application Publication
(10) Pub. No.: US 2005/0252608 A1
(43) Pub. Date: Nov. 17, 2005

(54) Method for bonding thermoplastic or thermoset polymeric materials utilizing voltage applied to conductive material

(76) Inventor: David M. MacDonald, Cumbria (GB)

Correspondence Address: STITES & HARBISON PLLC, 1199 NORTH FAIRFAX STREET, SUITE 900, ALEXANDRIA, VA, 22314, US

(21) Appl. No.: 10/501,070

(22) PCT Filed: Jan. 9, 2003
(86) PCT No.: PCT/US03/00536

§ 371 Date: Jun. 6, 2005

Related U.S. Application Data
(60) Provisional application No. 60/346,277, filed on Jan. 9, 2002.

(51) Int. Cl. B32B 31/00

(52) U.S. Cl. 156/273.9; 156/277

(57) ABSTRACT

A method for bonding or joining thermoplastic or thermoset polymeric materials is provided which comprises applying a layer of conductive material (16) at a joint or between surfaces of thermoplastic or thermoset polymeric materials (12, 14), introducing a current so as to raise the temperature of the polymeric material above its melting point, maintaining the current for a time sufficient to allow the polymeric material to become molten and thereby form the joint or bond, and then removing the current and allowing the joint or bond (15) to cool. The method is advantageous in that it provides a simple and inexpensive means of bonding thermoplastic or thermoset polymeric materials with a minimum of materials and equipment The method of the present invention can also be utilized so as to heat thermoplastic pipes and other devices made of thermoplastic materials.

### CROSS-REFERENCE TO RELATED APPLICATIONS

This application claims the benefit of U.S. Provisional Application Ser. No. 60/346,277, filed Jan. 9, 2002.

### FIELD OF THE INVENTION

This invention relates in general to a method for bonding thermoplastic or thermoset polymeric materials, and in particular to a method and product of said method wherein a conductive material such as a carbon voile or a conductive paint or ink is applied to a joint surface or to a location between two surfaces to be bonded, and an electrical current is applied to the conductive material so as to heat the polymeric materials above their melting point and allow a bond to form between the two polymeric surfaces.

### BACKGROUND OF THE INVENTION

Joining two pieces or parts made of polymers is normally achieved using a variety of methods of introducing energy into the joint face. These methods include vibrating the two surfaces together, using ultra-sonic vibration to excite the material at the interface, using radio frequency electromagnetic energy to cause the interface to be heated, heating the two surfaces independently and bringing the surfaces together in a molten state, adding heat energy at the outside surfaces such that it is conducted to the interface. All of these methods use complex machinery and are generally inefficient and hard to use accurately, and thus are very limited in their use.

There is thus a distinct need in the field to develop methods of bonding thermoplastic or thermoset polymeric materials devices which can be simple and inexpensive to use, which provides a rapid and precise thermal bond which is of excellent strength and durability, and which can be achieved with readily available and easy-to-incorporate materials.

### SUMMARY OF THE INVENTION

Accordingly, it is thus an object of the present invention to provide a method for bonding thermoplastic or thermoset polymeric materials utilizing conductive materials strategically located at a joint or between two polymeric surfaces to be bonded.

It is further an object of the present invention to provide a method wherein induction of a suitable electrical current applies a voltage to conductive materials at a joint or other bonding surface which heats the thermoplastic materials to be bonded such that the materials become molten and form a joint or bond between the surfaces.

It is still further an object of the present invention to provide a method wherein a carbon voile or a conductive paint or ink is applied to a joint or between sheets of thermoplastic material which will ultimately be utilized to heat the materials and form the bond or joint when a voltage is created in the carbon voile or conductive paint or ink.

It is even further an object of the present invention to provide an efficient and inexpensive method of forming a joint or bond in polymeric materials using conductive carbon or other suitable conductive materials, and to provide welded or joined thermoplastic materials obtained by said method.

These and other objects are achieved by virtue of the present invention which provides a method and product produced thereby which comprises applying a layer of conductive material at a joint or between surfaces of thermoplastic or thermoset polymeric materials to be bonded or joined, introducing a suitable voltage or current to the conductive material so as to raise the temperature of the polymeric material above its melting point, maintaining the voltage or current for a time sufficient to allow the polymeric material to become molten and thereby form a joint or bond, and then removing the voltage or current so as to allow the joint or bond to cool. Utilizing the method of the present invention, a simple and inexpensive means is provided to allow bonding and joint formation of suitable thermoplastic or thermoset polymeric materials in an efficient and precise manner. The method of the present invention can also be utilized so as to heat thermoplastic pipes and other devices made of thermoplastic materials.

These and other features of the present invention as set forth in, or will become obvious from, the detailed description of the preferred embodiments provided hereinbelow.

### BRIEF DESCRIPTION OF THE DRAWING FIGURES

FIG. 1 is a side schematic view of thermoplastic or thermoset polymeric sheets positioned to be bonded using the method of the present invention.

FIG. 2 is a top view of the thermoplastic or thermoset polymeric sheets of FIG. 1.

### DETAILED DESCRIPTION OF THE PREFERRED EMBODIMENTS

In accordance with the present invention, there is provided a method for bonding or joining thermoplastic or thermoset polymeric materials which in general comprises the steps of applying a layer of conductive material between two thermoplastic or thermoset polymeric surfaces to be bonded or formed into a joint; introducing a voltage to the conductive material so as to cause the surfaces of the polymeric material to heat to a temperature above their melting point and maintaining said voltage until such time as the surfaces of the polymeric materials become molten and a bond or joint forms between the surfaces; and removing said voltage and allowing the bonded thermoplastic materials to cool to a temperature below their melting point so as to solidify said bond or joint. As indicated in more detail below, the conductive material utilized along with the thermoplastic or thermoset polymeric materials may be any suitable conductive material such as a carbon fiber, e.g., in the form of a sheet or voile, or a suitable conductive paint or ink which may be applied to the thermoplastic surface via standard screen printing techniques.

In accordance with the invention, the invention may be utilized along with any of the many known thermoplastic or thermoset polymeric materials that would be familiar to those of ordinary skill in the pertinent art. For example, suitable polymeric materials would include such thermopolymers as polymers, copolymers or mixtures thereof which can be formed into suitable thermoplastic materials, e.g., into sheets, pipes, planters, etc., and such suitable polymeric materials can include polyethylene, polypropylene and other polyolefins, polyethylene terephthalate and other polyesters; polyamides; polyimides; polystyrene and other vinyl polymers, nylon, ABS and PC-ABS. One such sheet material particularly suited for use in the method of the present invention is high density polyethylene or HDPE. Still other suitable polymers are disclosed in U.S. Pat. Nos. 4,594,203; 3,975,473; 3,988,401; and 4,148,954, said patents incorporated herein by reference.

In the preferred embodiments, as set forth in more detail below, a suitable conductive material is employed between two thermoplastic or thermoset materials to be bonded or formed into a joint, and this material is preferably applied either by coating at least one of the two surfaces to be joined, or by inserting a conductive carbon fiber sheet or voile between the two polymeric materials to be joined. When applied in the form of a conductive coating, the preferred method is to apply a conductive ink or paint to one of the two surfaces to be joined or bonded. Wherein the conductive ink or paint is applied, these may be applied using any conventional application technique including standard screen printing techniques. There are many suitable conductive inks and paints that are well known in the field and which will be useful in accordance with the present invention, and these include conductive paints such as those disclosed in U.S. Pat. No. 4,499,010, incorporated herein by reference, and conductive inks such as those disclosed in U.S. Pat. Nos. 4,369,269 and 4,443,495, also incorporated herein by reference. When using the carbon voile, it is preferred that the carbon voile be inserted at the interface between the surfaces to be bonded, and it is preferred that that carbon voile have an approximate density of less than 10 grams per square meter. It is also possible that the carbon voile may be lightly pierced if so desired.

In either of these embodiments, it is also preferred that a conductive metallic tape or wire be applied in a suitable manner so as to provide a conductive pathway for the application of current or voltage to the conductive material forming the bond. In both cases, the conductive tape or wire may be applied along the opposite sides or ends of the carbon voile or the conductive compound so that a current may be directed to the bonding interface when necessary. The tape or wire may be applied in a manner so that it is removable once bonding is completed, or it may be of a material that will be compatible with the thermoplastic and thus become a permanent part of the joint or bond when completed. In addition, in the preferred process, the materials to be bonded or formed into a joint are preferably clamped together in a suitable manner before applying the bonding voltage, and such clamping may be obtained using mechanical pressure, e.g., via a conventional clamp or other mechanical means, and may also be obtained by adjustment of atmospheric pressure, e.g., by evacuation or drawing a vacuum on the site of joining or bonding to keep the surfaces of the polymeric materials in place throughout the bonding process.

There are many suitable methods for carrying out the present invention including those specific embodiments as described below. The main feature of the present invention is the utilization of the conductive properties of a suitable conductive material such as carbon, such as a conductive paint or ink or a carbon voile, which can introduce thermal energy to a joint surface or to the interior of a thermoplastic or composite by incorporating the carbon fiber or conductive material (e.g., a conductive paint or ink) into the bonding location or joint and by applying a low voltage to the carbon material. The conductive material, e.g. carbon voile (at approximate density of 10 grams per square meter or less) or conductive ink or paint, is introduced into a joint or between sheets of the thermoplastic or thermoset material. Alternatively, the conductive material, in particular when in the form of a conductive ink or paint, may preferably be coated onto one or both of the surfaces to be joined or bonded, and such coating may be applied using suitable techniques such as standard screen printing techniques. In either case, it is also preferred that a metallic conductive tape or wire be applied along the opposite sides or ends of the carbon voile or other conductive material, and such tape or wire is useful in applying a voltage suitable to heat the thermoplastic material above its melting point until a bond or joint is formed in accordance with the invention.

As indicated above, the conductive material may comprise a welding tape made up of a carbon fiber sheet or voile edged with a narrow conductive tape or band. The tape can also be furnished with adhesive properties so that the joint is held in place while the weld occurs. The carbon sheet or voile is then preferably sandwiched between the two polymeric surfaces to be joined. In the alternative, the voile can be incorporated into a thermoset composite by placing the voile between two layers of thermoset, preferably in the ‘tack’ stage of polymerization. Alternatively, the conductive material may comprise a conductive compound in the form of a conductive paint or ink, and in this case, the compound is applied and allowed to dry, after which a conductive metallic strip, e.g., one with a self-adhesive on one or both sides, is applied to the conductive material, preferably at the sides or ends. In either such instance, the voile or the conductive compound is bounded on two opposite edges with a conductive wire or tape, the ends of which protrude beyond the periphery of the completed sheet. As described further below, when a low voltage is applied to the material through the conductive tapes or wires, the surface temperature of the sheet is raised to the desired level and maintained at that level such that the sheet acts as a radiator. The invention can thus be used as a wall radiator, for heated floors or ceilings, or to make heated tanks or containers and in other applications.

It is also preferred that when forming the joint or bond, the polymeric materials to be joined or bonded are clamped together using either mechanical pressure or by evacuating the joint itself relying on atmospheric pressure to apply pressure (e.g., vacuum pressure) to the joint. When clamped in suitable position to maintain an interface between the surfaces to be bonded or joined, a voltage is applied, the magnitude of which is dependent on the length and width of the joint, but which will be suitable to raise the temperature of the polymeric materials to above the melting point for a time sufficient to form the bond or joint. Thus, the voltage applied so as to cause a current of sufficient strength to be applied to raise the temperature within the joint to above the melt point of the plastic. At that point, the plastic flows through the fine interstices in the carbon voile, or through the conductive coating material, and a structural joint or bond is achieved. In the preferred process, the voltage applied is a low voltage, but this voltage should be suitable to melt the polymers and form the bond in a rapid time period, even as little as ten seconds or less in the particularly preferred embodiment.

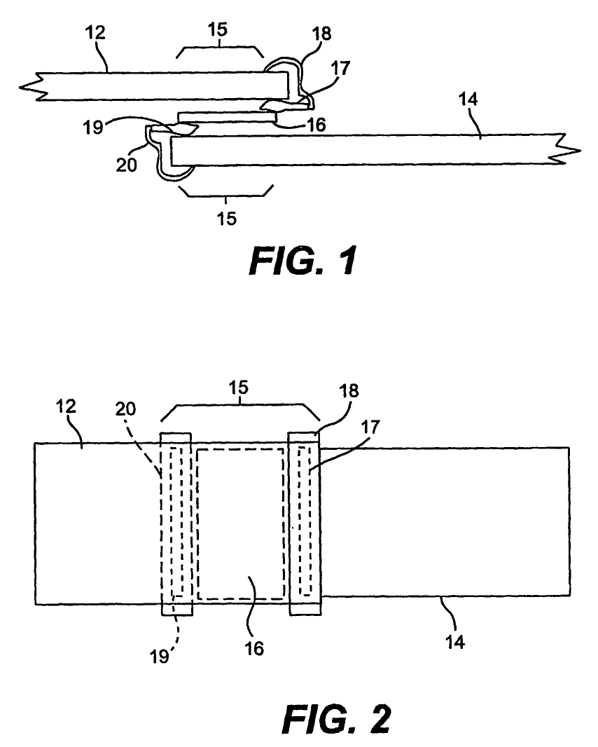

The present invention is illustrated further in the accompanying drawing figures which show suitable thermoplastic sheets or panels in position for the bonding method of the invention. As shown in the side view of FIG. 1 and then top view of FIG. 2, the present invention allows the formation of a bond between two thermoplastic or thermoset polymeric materials such as a top sheet 12 and a bottom sheet 14 which are to be joined together in the zone of overlap, generally shown at 15. In the embodiment shown in the drawing figures, the conductive material placed between the two panels or sheets to achieve bonding is a conductive carbon voile 16 which is inserted in sandwich fashion between top sheet 12 and bottom sheet 14. In the embodiment illustrated in the drawing figures, strips of conductive tape, 17 and 19, are placed in contact with the carbon voile 16 and with sheets 12 and 14 so as to allow a current to be introduced into the carbon voile that will ultimately cause heating and bonding between the sheets 12 and 14. In the preferred embodiment, the conductive tape is a metallic tape with adhesive fixed upon both sides so that the tape stays in contact with the carbon voile and the sheets during the bonding process, and the tapes are designed so that one will act as a positive electrode and one will act as a negative electrode.

In the preferred process as described above, the sheets 12 and 14 may be clamped in place by any suitable means capable of applying mechanical pressure, such as a clamp, a press or other suitable clamping device. Alternatively, as observed in the drawing figures, the area to be bonded may be kept in place by means of a vacuum pressure, and thus in this embodiment, adhesive tape 18 is used over the end of sheet 12 and conductive tape 17, and adhesive tape 20 is used over the end of sheet 14 and conductive tape 19 so that the bonding area will hold a vacuum applied by suitable evacuating means (not shown). The adhesive tape elements 18 and 20 are preferably removed following the bonding procedure.

In the preferred process of the invention, sheets 12 and 14 are bonded by applying an electrical current or voltage to voile 18 by means of an electrical connection from a transformer or other suitable electrical source (not shown), and the current is applied via the conductive tape elements 17 and 19 so that panels 12 and 14 heat up above their melting point and become molten so that a bond forms in the overlap region 15. Following formation of the bond, which can occur by administration of suitable voltage for as little as 10 seconds or less, the voltage is removed from the system, and the bonded sheets 12 and 14 are allowed to cool down so as to solidify the bond. In the preferred process, adhesive tape elements 18 and 20 are removed following formation of the bond and withdrawal of the vacuum pressure that originally kept the panels 12 and 14 in place.

In terms of the application of voltage and the particular sizes and compositions of the polymeric materials used in the invention, a wide range of polymers can be welded using the present method, and these have employed materials of different sizes and thickness. In general, for each application, the general method is to establish the amount of heat energy required to melt the plastic, allowing an average thickness to be melted of some 1.0 mm or less. By determining the resistance of the conductive film or voile in the joint, the energy in joules/sec that is delivered for a given voltage can be calculated. The time taken to weld the joint can therefore be calculated.

The resistance of the conductive layer will be proportional to the width of the conductive film and a formula is then used to determine the combination of voltage and time best suited to the size and architecture of the joint.

In typical examples of the method of the invention, using polyolefins such as polypropylene or polyethylene, a joint line 12 mm wide and 100 mm long may be welded in about 4.0 seconds, applying a voltage of about 70 volts to the carbon voile. The time required is proportional to the applied voltage, and as indicated above, the actual voltage applied in any particular case will be based at least in part on the conditions and thicknesses of the materials involved. In addition, where the conductive compound is used, the resistance is lower and a higher voltage is therefore applied.

By utilizing the method of the present invention, one achieves benefits not heretofore possible using prior methods. These benefits of the method include the ability to use simple and inexpensive convention equipment, e.g., a variable transformer capable of adjusting the voltage to the desired level while fitted with appropriate conventional and readily available safety devices such as a timer and an earth leakage circuit breaker, and low cost metallic tape. Moreover, the method offers the benefit of an extremely rapid welding process being achieved typically in less than 10 seconds for a significant weld area and giving good structural integrity, particularly where the weld area is reinforced by the carbon fibre voile material. In addition, other significant advantages of the present invention are obtained in that the molten thermoplastic is at all times protected from the atmosphere such that no oxidation takes place. A further advantage is that the outside surfaces of the joint are in no way affected by the weld and therefore delicate materials and finishes can be welded without damage.

Even further advantages are realized in that the system can be used to weld materials containing reinforcing fibres where very high joint pressures can be applied to ensure that the joint retains the full strength of the parent materials. Because it is only the joint surfaces that are heated, and because that heating may be achieved rapidly and maintained only for a short period, very high pressures can be applied to ensure that the strongest possible joint is obtained.

In other embodiments of the present invention, the present method and materials may also be utilized to bend thermoplastic or thermoset materials such as large sheets of thermoplastic. In this method, in general, the method comprises applying a layer of conductive material as described above to a suitable thermoplastic or thermoset polymeric material, introducing a voltage to the conductive material so as to cause the surface of the polymeric material to heat to a temperature above its melting point and form a bendable portion in the thermoplastic or thermoset polymeric material, bending said polymeric material to a desired angle; and removing said voltage after said desired bending angle is achieved to allow the thermoplastic or thermoset polymeric material to harden at the desired angle. In the preferred process, the bending is carried out by incorporating a thin carbon sheet voile or tape, or by coating or printing a suitable strip of conductive material, such as the inks or paints described above, and in the particularly preferred embodiment, this conductive material is applied with a width equal to approximately ten times the thickness of the sheet. When a low voltage is applied to the voile or tape, or conductive compound as described above, the material can be heated and as a result easily formed into a bend of the desired angle and radius. In accordance with the invention, the welding tape or sheet can also be used to heat pipes, valves and similar fittings to prevent the contents of the pipes freezing or become viscid. In this application of the present invention, it is preferred that the tape be wrapped around the pipe in lengths of not more than 120 inches, with care being taken to leave a gap between each wrapping of the tape around the pipe. The outside surface is then wrapped with a thermoplastic or fabric tape, capable of withstanding the operating temperature and a low voltage applied to the carbon tape end to end to raise and maintain the temperature of the pipe or fitting.

In yet another embodiment of the present invention, it is possible to use the conductive sheet or tape of the invention to heat a suitable thermoplastic planter, such as the “Earth Box®” which is disclosed in U.S. Trademark Registration No. 1,906,561, and in U.S. Pat. Nos. 5,555,675; 5,524,387; 5,379,547; 5,193,306 and 5,103,584, said patents and trademark registrations incorporated herein by reference). In this process, a strip of polymer material in which is embedded a strip of carbon fibre voile (or a conductive coating as described above) is applied or affixed to the inside or outward side of the Earth Box® The strip of polymer material would typically incorporate a backing sheet, between the strip and the side of the Earth Box®, of reflective foil. The strip would typically be maintained at a temperature above ambient by the application of a low voltage current in the manner as set forth above.

It is thus submitted that the foregoing embodiments are only illustrative of the claimed invention and not limiting of the invention in any way, and alternative embodiments that would be obvious to one skilled in the art not specifically set forth above also fall within the scope of the claims.

The following example is presented as illustrative of the present invention or methods of carrying out the invention, and is not provided as restrictive or limiting of the scope of the invention in any manner.

### EXAMPLE

A wide range of polymers have been welded using the method of the present invention, and these have employed materials of different sizes and thickness. In general, for each application, the general method is to establish the amount of heat energy required to melt the plastic, allowing an average thickness to be melted of some 1.Omm or less. By determining the resistance of the conductive film or voile in the joint, the energy in joules/sec that is delivered for a given voltage can be calculated. The time taken to weld the joint can therefore be calculated.

The resistance of the conductive layer will be proportional to the width of the conductive film and a formula is then used to determine the combination of voltage and time best suited to the size and architecture of the joint.

In one specific example, using polyolefins such as polypropylene or polyethylene, a joint line 12 mm wide and 100 mm long is welded in 4.0 seconds, applying a voltage of 70 volts to the carbon voile. The time required is proportional to the applied voltage. Where the conductive compound is used, the resistance is lower and a higher voltage is therefore applied.

1. A method for bonding or joining thermoplastic or thermoset polymeric materials comprising:
(a) applying a layer of conductive material between two thermoplastic or thermoset polymeric surfaces to be bonded or formed into a joint;
(b) introducing a voltage to the conductive material so as to cause the surfaces of the polymeric material to heat to a temperature above their melting point and maintaining said voltage until such time as the surfaces of the polymeric materials become molten and a bond or joint forms between the surfaces; and
(c) removing said voltage and allowing the bonded thermoplastic materials to cool to a temperature below their melting point so as to solidify said bond or joint.

2. The method of claim 1 wherein the two polymeric surfaces are clamped together before the introduction of a voltage.

3. The method of claim 2 wherein the two polymeric surfaces are clamped using either mechanical pressure or by evacuation to create a vacuum pressure at the interface between the two surfaces.

4. The method of claim 1 wherein the conductive material comprises a conductive carbon fiber in the form of a sheet or voile.

5. The method of claim 1 wherein the conductive material comprises a conductive ink or paint.

6. The method of claim 5 wherein the conductive ink or paint is applied to at least one of the two polymeric surfaces to be bonded or formed into a joint.

7. The method of claim 5 wherein the conductive ink or paint is applied using standard screen printing techniques.

8. The method of claim 1 wherein the thermoplastic or thermoset polymeric materials are selected from the group consisting of polyethylene, polypropylene and other polyolefins, polyethylene terephthalate and other polyesters; polyamides; polyimides; polystyrene and other vinyl polymers, nylon, ABS and PC-ABS.

9. The method of claim 4 wherein the carbon voile has an approximate density of less than 10 grams per square meter.

10. The method of claim 1 wherein a metallic conductive tape or wire is applied along the opposite sides or ends of the conductive material for the purpose of applying an electrical current across the conductive material.

11. The method of claim 10 wherein the conductive tape or wire is removed following the bonding or joint forming process.

12. The method of claim 1 wherein the voltage is applied for 10 seconds or less.

13. A thermoplastic or thermoset polymeric material having a joint or bond formed by the method of claim 1.

14. A method for bending a thermoplastic or thermoset polymeric material comprising:
(a) applying a layer of conductive material to thermoplastic or thermoset polymeric material;
(b) introducing a voltage to the conductive material so as to cause the surface of the polymeric material to heat to a temperature above its melting point and form a bendable portion in the thermoplastic or thermoset polymeric material;
(c) bending said polymeric material to a desired angle; and
(d) removing said voltage after said desired bending angle is achieved to allow the thermoplastic or thermoset polymeric material to harden at the desired angle.

15. The method of claim 14 wherein the polymeric material is in the form of a sheet.

16. A method for heating a thermoplastic or thermoset polymeric material comprising:
(a) applying a layer of conductive material to thermoplastic or thermoset polymeric material;
(b) introducing a voltage to the conductive material so as to cause the surface of the polymeric material to heat to a temperature above its melting point; and
(c) removing said voltage after heating is no longer desired.

17. The method of claim 16 wherein the polymeric material is in the form of a pipe or a planter.

18. The method of claim 16 wherein the polymeric material is in the form of a wall radiator.
